(19) United States
(12) Patent Application Publication
(10) Pub. No.: US 2005/0213925 A1
(43) Pub. Date: Sep. 29, 2005

(54) Fiber channel switching system

(75) Inventor: Moshe Czeiger, Haifa (IL)

Correspondence Address: KATTEN MUCHIN ROSENMAN LLP, 575 MADISON AVENUE, NEW YORK, NY, 10022-2585, US

(73) Assignee: IMPERATIVE NETWORKS LTD.

(21) Appl. No.: 11/086,081

(22) Filed: Mar. 22, 2005

Related U.S. Application Data
(60) Provisional application No. 60/555,310, filed on Mar. 23, 2004.

(51) Int. Cl. G02B 6/00

(52) U.S. Cl. 385/147

(57) ABSTRACT

The present invention discloses a distributed switching system and method for fibre channel data transfer. The preferred embodiment of the present inventions is a simple distributed switching algorithm which ensures high bandwidth utilization and statistical fairness of resource usage without having to rely on complex and expensive central switching management architectures. The algorithm, which operates on two interrelated round-robin selection mechanisms—at the output ports and at the input ports—enables head of queue reduction, since output port schedule an input port only when there is a place in output FIFO. The crossbar, then, supports only frames that are just about to leave the switch. It also allocates minimum data storage per buffer, wherein the buffers are defined as dedicated memory allocated in each input port. Such a method is efficient for achieving memory reduction, especially for multiple ports systems in which a large amount of data is transferred.

### CROSS REFERENCE TO RELATED APPLICATION

This application claims priority from provisional application 60/555,310 filed on Mar. 23, 2004.

### FIELD OF THE INVENTION

The present invention relates in general to the field of fiber channels switching systems, and more particularly it relates to the queuing algorithms for fiber channel switch.

### BACKGROUND OF THE INVENTION

The tremendous growth and complexity of business-generated data is driving the demand for cost-effective storage solutions and tools designed to manage large amounts of data efficiently. One such solution is a serial data transfer architecture known as Fibre Channel. Fibre Channel is a high speed pipe (up to 10 Gbps) used for data transfer which provides a logical bi-directional, point-to-point connection between two devices. One of the main benefits is that it is designed specifically for storage services (e.g. between host and storage device). Therefore, more recently Fibre Channel has evolved as the architecture of choice for many storage area networks and is ideally suited to this role because it is very reliable, very scalable, and very flexible.

Storage network architecture can be implemented either with copper wires or with fibre optic technologies. Fibre optic technology is excellent for transmitting data across a network because of the reliability of the fibre. Fibre Channels use channel establishment and frames for transferring data, most of the frames are approximately 2 KB in size. Every frame contains information to be transmitted, the address of the source and destination ports and link control information. Channel establishment is done either through switched or direct point-to-point connections. The channels are created as a fixed connection between the source and destination devices for the complete data transfer session, providing a rapid data transfer activity, since there is overhead only at the handshake phase of the connection of software between the user and the switched environment. In comparison with the “channel/frame” architecture described above, a regular data network is an aggregation of distributed nodes (like workstations, file servers etc.) handling more then deterministic data interactions.

Over the last few years, Fibre Channel has moved to a new and much better topology based on a switch, known as ‘fabric’. One switch would have a number of ports on it for allowing multiple devices to be connected directly to the switch. The primary function of the Fabric is to receive the frames from the source port and route them to the destination port. The channel architecture, having many layers of communication, provides common services to its clients and thus improving efficiency and providing advanced features such as the ability for more than one port to respond to the same alias address.

Storage Area Networks (SAN's) are high-speed networks, which use the Fibre Channel architecture and protocol to enable deployment of comprehensive storage services which are becoming mission critical to businesses. A single SAN is a group of storage devices connected via a network to a host computer or servers and its architecture makes all storage devices available to the host and servers on a LAN. As more storage devices are added to a SAN, they too become accessible from any server or hosts in the larger network. In this case, the servers and hosts merely act as a pathway between the end users and the stored data devices. Storage Area Networks are not new in data storage however they are increasing in popularity due to high demand by users who need to store large volumes of data. In conclusion, the key benefits of Fibre Channel SAN networks are their ability to free the LAN from being the path for massive backup activity, and enabling the enlargement of storage capability while simplifying the switched environment.

The following architectures are known in the art for the queuing task: the shared memory, the mash, the output queues and the virtual output queues. The shared memory operates without a matrix; a single shared memory serves all ports. The mesh architecture also does not utilize a matrix. Its operation relies on a mesh of buses connecting each input port to a buffer at each output connection. The output queues architecture operates by sending data from each input buffer to the proper queue at the output port. The algorithm correlating between input and output ports may operate simply by finding a non-correlated output port, or managed by a central switching logic.

The virtual output queues architecture is based on the output queues architecture, but in addition it also includes at each input port a memory unit for every output port. This memory unit contains pointers for the input buffers which store the data frames. The input-output correlation algorithm may operate simply by selecting an available output port or managed by a central switching logic. The main drawback of the simple correlation algorithm is that it does not ensure an optimized usage of resources, especially of bandwidth capabilities. On the other hand, the centralized management algorithm enables simple management of the scheduling scheme, but it needs to make a scheduling decision during every cell time, a calculation whose level of complexity is N². As the line speed increases, the cell time is shortened such that the scheduler has a hard time finishing the scheduling task, which highly limits the measure of scalability of this solution, and makes its implementation complex and expensive.

There is therefore a need for an algorithm and architecture for performing the switching management which is simple and does not require performing complex calculations, while offering scalability, ensuring high bandwidth utilization, and statistically fair usage of the system's resources.

### SUMMARY OF THE INVENTION

Disclosed is a distributed switching system for fibre channel data transfer. The system includes multiple input ports and output ports, a crossbar matrix and multiple DMA for switching between the input ports and output ports. The system further comprises multiple buffers for each input port allocated dynamically for each incoming data frame; multiple output ports modules for electing and granting one input port transfer request out of multiple transfer request of different input ports; multiple input ports module for selecting between granted elections of the output ports modules of the same transfer request; and masking module for informing all the output ports which were not selected for a specific transfer request.

The selection of the output ports modules and input port modules are based on a round-robin algorithm. The system also includes pointers FIFOs which hold pointers for the buffers of incoming frames for initiating transfer requests of incoming frames. The grant of an output port is authorized only if the port is ready to transmit and the total amount of memory to be allocated to the buffers is fixed.

The present invention discloses a distributed switching system for fibre channel data transfer. The system includes multiple input ports and output ports, a Crossbar Matrix and multiple DMA for switching between the input ports and output ports. The system also includes multiple buffers for each input port allocated dynamically for each incoming data frame; pointer FIFOs holding a pointer for each buffer which holds an incoming frame for initiating transfer request for each frame; input selector for each output port for electing and granting one transmission requests between all input ports in accordance with a round-robin algorithm; grant selectors for selecting between all received grants for each transfer request in accordance with a round-robin algorithm and informing the DMA; and request masks for each input port for sending cancellation notification for output ports which were not selected by the grant selector.

The disclosed invention also describes a distributed switching method for fibre channel data transfer between multiple input ports and output ports through a crossbar matrix and multiple DMA. The method is comprised of the following steps: allocating a buffer for each incoming frame at each input port; electing and granting at each output port one input port transfer request out of multiple transfer request of different input ports; selecting a single grant given to the same transfer request from the different output ports; and informing all the output ports which were not selected for a specific transfer request.

The selection is based on a round-robin algorithm and also included are pointers FIFO of pointers for buffers which holds an incoming frame for initiating transfer requests. The grant of an output port is authorized only if the port is ready to transmit and the total amount of memory to be allocated to the buffers is fixed.

### BRIEF DESCRIPTION OF THE DRAWINGS

These and further features and advantages of the invention will become more clearly understood in the light of the ensuing description of a preferred embodiment thereof, given by way of example only, with reference to the accompanying drawings, wherein—

FIG. 1 is an illustration of the proposed switch in a network configuration in accordance with the present invention.

FIG. 2 is a block diagram illustrating the illustrating main components and the mode of operation of the preferred embodiment of the present invention.

### DETAILED DESCRIPTION OF THE PREFERRED EMBODIMENTS

The present invention discloses a distributed switching system and method for fibre channel data transfer. The preferred embodiment of the present inventions is a simple distributed switching algorithm which ensures high bandwidth utilization and statistical fairness of resource usage without having to rely on complex and expensive central switching management architectures. The algorithm, which operates on two interrelated round-robin selection mechanisms, the first at the output ports and the second at the input ports, enables head of queue reduction, since output port schedule an input port only when there is a place in output First In First Out (FIFO). The crossbar, then, supports only frames that are just about to leave the switch. It also allocates minimum data storage per buffer, wherein the buffers are defined as dedicated memory allocated in each input port. Such a method is efficient for achieving memory reduction, especially for multiple ports systems in which a large amount of data is transferred. For example, when using 16 ports in which the buffers are located at the output ports, it is required to allocate for each port, the total number of buffers which are declared for storage in the network, whereas the proposed implementation allocates buffers to each input port from a pool of buffers.

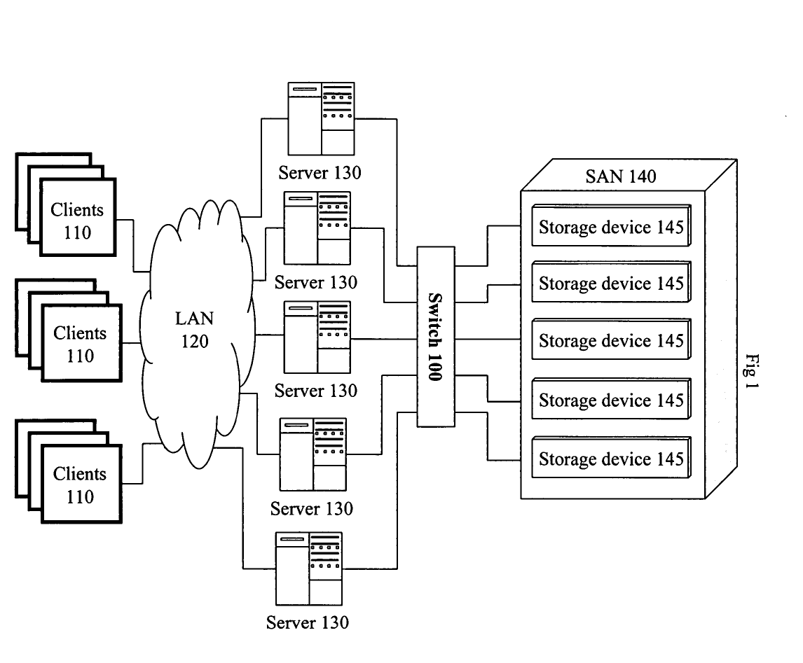

FIG. 1 is an illustration of a network configuration in which the proposed switch 100 may operate. The clients 110 communicate via LAN 120 with the Storage Area Network (SAN) 100 through the servers 130. For each server 130 the SAN 140 holds a dedicated storage device 145. All communication between the servers 130 and the SAN 140 is routed by switch 100.

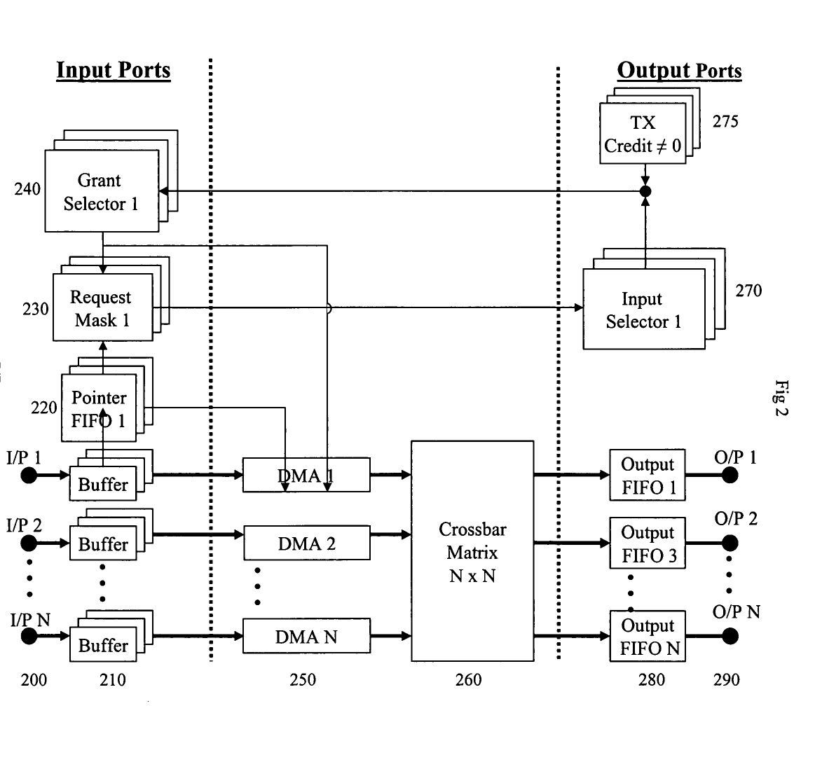

FIG. 2 is a block diagram illustrating the main components and the mode of operation of the preferred embodiment of the present invention. In this setting data frames are transferred from N input ports 200 to N output ports 290. The data frames travel through buffers 220 and direct memory access (DMA) 250. The Crossbar Matrix 260 executes the connectivity configuration between the input and the output lines at any given timeframe. Each input port 200 is connected to a limited number of buffers 220, the amount of which is determined according to the amount of available memory, and to a single DMA 250. Each output port 290 is connected to a single Output FIFO 280 and a single Crossbar Matrix 260 performs all connectivity.

The flow of information is managed by secondary management devices which include input Pointer FIFOs 220, Request Masks 230, Grant Selectors 240 and Input Selectors 270. Each of these devices stands for a plurality of devices, whereas for each input port 200 there are N Pointer FIFOs 220 (one for each output port), and a single Request Mask 230 and Grant Selector 240. Each Input Selector 270 is situated on a single output port 290. Therefore, for N amount of input ports (I/P 1 to N) 200 and N amount of output ports (O/P 1 to N) 290, there are N² input Pointer FIFOs 220, and N Request Masks 230, Grant Selectors 240 and Input Selectors 270.

Each data frame which arrives at input ports 200 is stored in a dedicated buffer 210 which is retrieved from a pool of buffers. The pointer of the buffer 210 is inserted into the appropriate Pointer FIFO 220 according to the frame port destination. Each active Pointer FIFO 220 sends a transfer request through the Request Mask 230 to its dedicated output port 290 Input Selector 270. Waiting requests in Pointer FIFOs 220 are transferred through the Request Mask 230 to the Input Selectors 270 of all the output ports according to their order of arrival. As aforementioned, for each input port there is N Pointer FIFOs 220, each dedicated to a single output port. Using this FIFO configuration enables the system to ensure that sequential data frames which are destined to arrive at a particular output port retain their order while avoiding bottlenecking since frames destined for different ports do not stall each other.

Each Input Selector 270 of each output port selects a particular transfer request in a round-robin manner and informs the Grant Selector 240 of the appropriate port about the transfer grant, provided that there is a no zero credit 275 for transfer from the port (the port is ready to transmit). If the Grant Selector 240 receives more then a single grant (from more then one output port) for the transfer request, it selects one of them in a round-robin manner and informs the Request Mask 230 and the DMA 250 of its selection. While the DMA 250 transfers the data frame through the Crossbar Matrix 260 to the selected output port, the mask request 230 sends a cancellation notification to all other output ports, releasing them to accept delivery requests from other input ports. At any given timeframe the Crossbar Matrix 260 transfers all data frames from its input lines to its output lines according to the configuration it receives from all active DMAs 250. The data frames are transferred to the Output FIFOs 280 of the output ports 290, and released to the port 290 from the FIFO 280 according to their order of arrival.

By providing both the input and the output devices with a simple round-robin selection mechanism, the transfer request management is in fact distributed across the devices and across independently operating selection functions. This mechanism offers a light-weight and flexible solution which is statistically fair and balanced, without having to relay on complex central management algorithms to perform connectivity optimizations. Such algorithms demand allocating significant calculation resources to execute the required calculations whose level of complexity is N2, while the level of complexity of the proposed solution is N.

The implementation of this switching system, wherein the buffers are allocated at the input ports, requires less complex buffer management (no need for table lists as all input addresses are stored in memory) and considerably reduces the hardware requirements (less logic, less physical memory) in comparison to systems which allocate the buffer at the output ports. Prior art methods, which use shared physical memory, demand a complex memory management in the switch environment. Furthermore, shared memory is inflexible and has little scope for modification and scalability.

This proposal is deterministic since the amount of memory and number of frames available for each switch is predetermined. It has a known amount of free available frames for storage at the destination port and the data transfer is therefore diverted accordingly—through the destination port or through alternative ports. For maximum efficiency, the total allocation in buffer size for each port should be larger than the length of the fibre. By keeping the length of the fibre smaller than the size of the dedicated buffer memory, the frame waits on the fibre itself if it cannot be stored in a free buffer. This configuration guarantees that enough memory is always available for each port.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

1. A distributed switching system for fibre channel data transfer, said system including multiple input ports and output ports, a crossbar matrix and multiple DMA for switching between the input ports and output ports, further comprising:
a. multiple buffers for each input port allocated dynamically for each incoming data frame;
b. multiple output ports modules for electing and granting one input port transfer request out of multiple transfer request of different input ports;
c. multiple input ports module for selecting between granted elections of the output ports modules of the same transfer request;
d. masking module for informing all the output ports which were not selected for a specific transfer request.

2. The system of claim 1 wherein the selection of the output ports modules and input port modules are based on a round-robin algorithm.

3. The system of claim 1 further including pointers FIFOs which hold pointers for the buffers of incoming frames for initiating transfer requests of incoming frames.

4. The system of claim 1 wherein the grant of an output port is authorized only if the port is ready to transmit;

5. The system of claim 1 wherein the total amount of memory to be allocated to the buffers is fixed.

6. The system of claim 1 wherein the total allocation in buffer size for each port is larger than the length of the fibre.

7. A distributed switching system for fibre channel data transfer, said system including multiple input ports and output ports, a Crossbar Matrix and multiple DMA for switching between the input ports and output ports, said system further comprised of:
a. multiple buffers for each input port allocated dynamically for each incoming data frame;
b. pointer FIFOs holding a pointer for each buffer which holds an incoming frame for initiating transfer request for each frame;
c. input selector for each output port for electing and granting one transmission requests between all input ports in accordance with a round-robin algorithm;
d. grant selectors for selecting between all received grants for each transfer request in accordance with a round-robin algorithm and informing the DMA;
e. request masks for each input port for sending cancellation notification for output ports which were not selected by the grant selector.

8. A distributed switching method for fibre channel data transfer between multiple input ports and output ports through a crossbar matrix and multiple DMA, comprising the steps of:
a. allocating a buffer for each incoming frame at each input port;
b. electing and granting at each output port one input port transfer request out of multiple transfer request of different input ports;
c. selecting a single grant given to the same transfer request from the different output ports;
d. informing all the output ports which were not selected for a specific transfer request;

9. The method of claim 8 wherein the selection is based on a round-robin algorithm.

10. The method of claim 8 further including pointers FIFO of pointers for buffers which holds an incoming frame for initiating transfer requests.

11. The method of claim 8 wherein the grant of an output port is authorized only if the port is ready to transmit.

12. The method of claim 8 wherein the total amount of memory to be allocated to the buffers is fixed.

13. The method of claim 8 wherein the total allocation in buffer size for each port is larger than the length of the fibre.
